(19) United States
(12) Patent Application Publication
(10) Pub. No.: US 2022/0152459 A1
(43) Pub. Date: May 19, 2022

(54) GOLF BALL

(71) Applicant: Bridgestone Sports Co., Ltd., Tokyo (JP)

(72) Inventor: Masahiro YAMABE, Chichibushi (JP)

(73) Assignee: Bridgestone Sports Co., Ltd., Tokyo (JP)

(21) Appl. No.: 17/513,224

(22) Filed: Oct. 28, 2021

(30) Foreign Application Priority Data
Nov. 19, 2020 (JP) 2020-192333

(51) Int. Cl. A63B 37/00

(52) U.S. Cl. CPC A63B 37/0024; A63B 37/0092; A63B 37/0083; A63B 37/0031

(57) ABSTRACT

In a golf ball having a core and a cover of one or more layer, at least one layer of the cover is formed of a resin composition which includes in a specific weight ratio: (I) a thermoplastic polyurethane resin that uses polytetramethylene glycol having a number-average molecular weight of from 1,900 to 2,100 as the polyol component, (II) a thermoplastic polyurethane resin that uses polytetramethylene glycol having a number-average molecular weight of from 900 to 1,100 as the polyol component, and (III) an aromatic vinyl elastomer. The cover layer formed of this resin composition has a Martens hardness and an elastic work recovery which together satisfy a specific formula. The golf ball has an excellent controllability on approach shots without losing distance on driver shots. In addition, the scuff resistance and moldability are good.

### CROSS-REFERENCE TO RELATED APPLICATION

This non-provisional application claims priority under 35 U.S.C. § 119(a) on Patent Application No. 2020-192333 filed in Japan on Nov. 19, 2020, the entire contents of which are hereby incorporated by reference.

### TECHNICAL FIELD

The present invention relates to a multilayer golf ball of two or more pieces having a core and a cover. More particularly, the invention relates to a golf ball that is endowed with an excellent spin performance on approach shots and also has an excellent scuff resistance and moldability.

### BACKGROUND ART

The property most desired in a golf ball is an increased distance, but other desirable properties include the ability for the ball to stop well on approach shots and a good scuff resistance. Many golf balls have hitherto been developed that exhibit a good flight performance on shots with a driver and are suitably receptive to backspin on approach shots. Also, materials endowed with a high rebound and a good scuff resistance have been developed as golf ball cover materials.

Urethane resin materials are often used in place of ionomer resin materials as such cover materials, particularly in golf balls for professional golfers and skilled amateurs. However, professional golfers and skilled amateurs desire golf balls having even better controllability on approach shots. Specifically, they want excellent maneuverability and more delicate control around the green with short irons such as a sand wedge (SW). To this end, further improvements are being sought in cover materials made using a urethane resin as the base resin.

A number of polymer blend-type cover materials obtained by using a urethane resin as the base resin and mixing other resins therein have been described in the art. For example, to improve the scuff resistance of the cover material, JP-A H11-9721 discloses the use of a blend composed of a thermoplastic polyurethane and a styrene-based block copolymer as the base resin of the cover. However, covers made of this blend are inadequate in terms of their rebound resilience and scuff resistance.

The properties of thermoplastic urethane elastomers have recently been upgraded, one such improved property being the scuff resistance. Hence, when blending another resin material into such a thermoplastic urethane elastomer, it is desired that a decrease in the scuff resistance inherent to the thermoplastic urethane elastomer be avoided through judicious adjustments in the type and content of the blended resin.

When blending a urethane resin material with another resin material for the purpose of lowering the hardness, it is also desired that changes in the rebound resilience and a worsening of the moldability be avoided to the extent possible.

In addition, JP-A 2010-238 discloses the use of, as the polyol component making up a polyurethane, a multimodal polyol having multimodality in the molecular weight distribution. However, this golf ball art does not take into account cover hardness, rebound and moldability, and so the controllability on approach shots and the moldability are likely to be inadequate.

### SUMMARY OF THE INVENTION

It is therefore an object of the present invention to provide a golf ball which has an excellent controllability on approach shots without lowering the distance traveled by the ball on shots with a driver, and which moreover has a good scuff resistance and moldability.

As a result of extensive investigations, I have discovered that a golf ball which has a high spin rate on approach shots and thus excellent controllability and which also retains a good scuff resistance and moldability can be obtained by using, as the cover-forming material in a golf ball having a core and a cover, a resin material which contains a thermoplastic polyurethane as the chief ingredient and which, to further improve the resin material, uses a polyol having a relatively low number-average molecular weight as the polyol component of the thermoplastic polyurethane, the resin material containing more specifically two types of urethane resin—a thermoplastic polyurethane resin that uses polytetramethylene glycol having a number-average molecular weight (Mn) of from 1,900 to 2,100 as the polyol component and a thermoplastic polyurethane resin that uses polytetramethylene glycol having a number-average molecular weight (Mn) of from 900 to 1,100 as the polyol component in a blending ratio within a given range, and moreover by preparing a cover-forming resin composition in which an aromatic vinyl elastomer is blended with these two types of urethane resins and producing a golf ball wherein, letting HMb (N/mm²) be the Martens hardness of the cover layer formed of this resin composition and ηItb (%) be the elastic work recovery of the cover layer, HMb and ηItb satisfy formula (1) below

2.00≤ηItb/HMb≤7.50 (1).

That is, when the cover layer is formed of a resin composition that uses a polyurethane as the chief ingredient, the softer the polyurethane resin used, the better the spin performance of the ball on approach shots, although such a ball has a high initial velocity and tends to be difficult to control on approach shots. I have found that by adding an aromatic vinyl elastomer in any amount, the initial velocity/controllability can be improved (meaning that the initial velocity is held down and a good controllability on approach shots is maintained) while retaining a good spin rate and scuff resistance. But excessively increasing the amount of aromatic vinyl elastomer included ultimately worsens the scuff resistance. I have thus focused on the compound design of the polyurethane resin itself that is used, and set out to further lower the resilience while retaining a good scuff resistance. When a high-molecular-weight polyol is used as the polyol component in polyurethane, the urethane crystallinity rises and the resilience increases. However, by adding a given amount of such a conventional polyurethane resin to a urethane resin in which the polyol component has a relatively low molecular weight, it was possible to reduce the crystallinity and lower the resilience of the urethane itself. This invention was ultimately arrived at by setting the ratio of the relatively low-molecular-weight polyol component with respect to the overall urethane resin within a specific range in order to retain a good cover layer moldability and by also specifying as indicated above the Martens hardness and elastic work recovery of this low-resilience cover layer.

Accordingly, the present invention provides a golf ball having a core of at least one layer and a cover of one or more layer encasing the core, wherein at least one layer of the cover is formed of a resin composition which includes:

(I) a thermoplastic polyurethane resin that uses, as a polyol component, polytetramethylene glycol having a number-average molecular weight of from 1,900 to 2,100,

(II) a thermoplastic polyurethane resin that uses, as a polyol component, polytetramethylene glycol having a number-average molecular weight of from 900 to 1,100, and

(III) an aromatic vinyl elastomer,

and in which components (I) and (II) are compounded in a weight ratio (II)/(I) of from 0.01 to 1.10. Letting HMb (N/mm²) be the Martens hardness of the cover layer formed of the resin composition containing components (I) to (III) and ηItb (%) be the elastic work recovery of the cover layer, HMb and ηItb satisfy formula (1) below

2.00≤ηItb/HMb≤7.50 (1).

In a preferred embodiment of the golf ball of the invention, ηItb/HMb in formula (1) has a lower limit value of 2.50 and an upper limit value of 6.50.

In another preferred embodiment of the inventive golf ball, the weight ratio (II)/(I) in which components (I) and (II) are compounded is from 0.05 to 0.8.

In yet another preferred embodiment, letting HMa (N/mm²) be the Martens hardness of the thermoplastic polyurethane resin material composed of components (I) and (II), the golf ball satisfies formula (2) below

1.005≤HMa/HMb≤1.450 (2).

In still another preferred embodiment, the content of component (III) is 50 parts by weight or less per 100 parts by weight of components (I) and (II) combined.

In a further preferred embodiment, component (III) is a hydrogenated aromatic vinyl elastomer.

In a yet further preferred embodiment, component (III) is an elastomer obtained by hydrogenating a polymer made up of polymer blocks composed primarily of an aromatic vinyl compound and a random copolymer block of an aromatic vinyl compound and a conjugated diene compound.

In a still further preferred embodiment, component (III) is a hydrogenated aromatic vinyl elastomer obtained by hydrogenating a polymer made up of at each of two ends thereof, a polymer block composed of styrene and, in between, a random copolymer block composed of styrene and butadiene.

In an additional preferred embodiment, the resin composition has a melt viscosity at 200° C. and a shear rate of 243 sec⁻¹ that is from 0.2×10⁴ to 2.5×10⁴ dPa·s.

### Advantageous Effects of the Invention

The golf ball of the invention has an excellent controllability on approach shots and also retains a good scuff resistance and moldability.

### BRIEF DESCRIPTION OF THE DIAGRAM

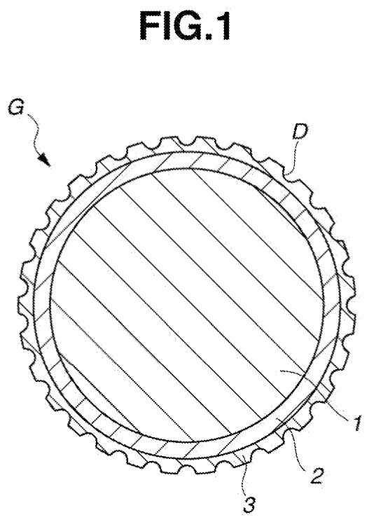

FIG. 1 is a schematic cross-sectional view of a golf ball according to one embodiment of the invention.

### DESCRIPTION OF THE PREFERRED EMBODIMENTS

The objects, features and advantages of the invention will become more apparent from the following detailed description taken in conjunction with the appended diagram.

The golf ball of the invention has a core of at least one layer and a cover of one or more layer encasing the core. For example, referring to FIG. 1, the ball may be a multi-piece solid golf ball G having a core 1, an intermediate layer (inside cover layer) 2 encasing the core 1, and an outermost layer (outside cover layer) 3 encasing the intermediate layer 2. The outside cover layer 3 is positioned as the outermost layer, aside from a coating layer, in the layer construction of the golf ball. Numerous dimples are generally formed on the surface of the outside cover layer (outermost layer) 3 in order to enhance the aerodynamic properties. Although not shown in the attached diagram, a coating layer is typically formed on the surface of the outside cover layer 3.

The core may be formed using a known rubber material as the base material. A known base rubber such as natural rubber or synthetic rubber may be used as the base rubber. More specifically, it is recommended that polybutadiene, especially cis-1,4-polybutadiene having a cis structure content of at least 40%, be chiefly used. If desired, natural rubber, polyisoprene rubber, styrene-butadiene rubber or the like may be used together with the foregoing polybutadiene in the base rubber.

The polybutadiene may be synthesized with a metal catalyst, such as a neodymium or other rare-earth catalyst, a cobalt catalyst or a nickel catalyst.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may be suitably added.

The core may be produced by vulcanizing/curing the rubber composition containing the above ingredients. For example, production may be carried out by kneading the composition using a mixer such as a Banbury mixer or a roll mill, compression molding or injection molding the kneaded composition using a core mold, and curing the molded body by suitably heating it at a temperature sufficient for the organic peroxide and the co-crosslinking agent to act, i.e., between 100° C. and 200° C., and preferably between 140° C. and 180° C., for a period of 10 to 40 minutes.

In this invention, at least one layer of the cover is formed with a resin composition containing components (I) to (III) below:

(I) a thermoplastic polyurethane resin that uses, as a polyol component, polytetramethylene glycol having a number-average molecular weight of from 1,900 to 2,100,

(II) a thermoplastic polyurethane resin that uses, as a polyol component, polytetramethylene glycol having a number-average molecular weight of from 900 to 1,100, and

(III) an aromatic vinyl elastomer.

Components (I), (II) and (II) are described in detail below.

### (I) Thermoplastic Polyurethane Resin

This polyurethane has a structure which includes soft segments composed of a polymeric polyol (polymeric glycol) that is a long-chain polyol and hard segments composed of a chain extender and a polyisocyanate. As noted above, at least two types of thermoplastic polyurethane resins, (I) and (II), are used in this invention.

A polytetramethylene glycol (PTMG) having a number-average molecular weight (Mn) of from 1,900 to 2,100 is used as the polymeric polyol. This PTMG results in a polyurethane resin that has a high crystallinity, which polyurethane resin is widely used as a golf ball cover layer, has a low resilience and is able to impart a good spin rate on approach shots and a good scuff resistance.

The long-chain polyol has a number-average molecular weight that is preferably in the range of 1,000 to 5,000. By using a long-chain polyol having a number-average molecular weight in this range, golf balls made with a polyurethane composition that have excellent properties, including a good rebound and good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method for preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use an ether-based thermoplastic polyurethane material as the above polyurethane. The thermoplastic polyurethane material used may be a commercial product, illustrative examples of which include those available under the trade name PANDEX from DIC Covestro Polymer, Ltd., and those available under the trade name RESAMINE from Dainichiseika Color & Chemicals Mfg. Co., Ltd.

### (II) Thermoplastic Polyurethane Resin

A polytetramethylene glycol (PTMG) having a number-average molecular weight (Mn) of from 900 to 1,100 is used as the polymeric polyol in thermoplastic polyurethane resin (II). By using this thermoplastic polyurethane resin having a relatively low molecular weight PTMG together with above component (I), a golf ball having a low resilience, a low resilience, a good spin rate on approach shots and a good scuff resistance can be imparted.

Aside from the above polymeric polyol, the explanation of thermoplastic polyurethane resin (II) is the same as for thermoplastic polyurethane resin (I).

In this invention, component (I) and component (II) are compounded in relative proportions which are adjusted such that the weight ratio (II)/(I) therebetween is from 0.01 to 1.10, and preferably from 0.05 to 0.8. When the amount of component (II) included is excessive and exceeds the above range, the ability of the resin material to solidify during molding of the cover layer worsens and molding defects may arise. On the other hand, when the ratio is smaller than the above range, the amount of component (II) included becomes too low, as a result of which low resilience of the resin itself is not fully achieved and the ball may lack controllability on approach shots.

The thermoplastic polyurethane resins serving as components (I) and (II) together serve as the base resin of the resin composition, accounting for preferably at least 50 wt %, more preferably at least 60 wt %, even more preferably at least 70 wt %, still more preferably at least 80 wt %, and most preferably at least 90 wt %, of the resin composition.

### (III) Aromatic Vinyl Elastomer

Next, the aromatic vinyl elastomer (III) is described.

The aromatic vinyl elastomer is a polymer (elastomer) made up of a polymer block composed primarily of an aromatic vinyl compound, and a random copolymer block composed of an aromatic vinyl compound and a conjugated diene compound. That is, the aromatic vinyl elastomer generally has, as exemplified by SEBS, blocks composed of an aromatic vinyl compound component which are located at both ends of the polymer and serve as hard segments, and a block composed of a conjugated diene compound component which is located between the ends and serves as a soft segment. Polymers wherein an aromatic vinyl-based component has been randomly introduced into the conjugated diene compound component making up the intermediate block have also been reported in recent research. The hardness of the aromatic vinyl elastomer generally becomes lower as the content of the aromatic vinyl that forms the hard segments decreases; at the same time, because the amount of the soft segment component increases, the rebound resilience rises. On the other hand, in cases where the aromatic vinyl component is randomly introduced into the soft segments of the intermediate block, the rebound resilience decreases with little if any rise in the hardness. A similar effect can be obtained by using a conjugated diene compound having a high glass transition temperature (Tg) in place of the aromatic vinyl compound that is randomly introduced into the intermediate block. In the present invention, to fully exhibit the above working effects, it is particularly desirable to use the above polymer (elastomer) in a hydrogenated form.

Examples of the aromatic vinyl compound in the polymer include styrene, α-methylstyrene, p-methylstyrene, divinylbenzene, 1,1-diphenylethylene, N,N-dimethyl-p-aminoethylstyrene and N,N-diethyl-p-aminoethylstyrene. These may be used singly, or two or more may be used together. Of these aromatic vinyl compounds, styrene is preferred.

Examples of the conjugated diene compound in the polymer include butadiene, isoprene, 2,3-dimethyl-1,3-butadiene, 1,3-pentadiene, 2-methyl-1,3-pentadiene and 1,3-hexadiene. These may be used singly, or two or more may be used together. Of these compounds, butadiene and isoprene are preferred. Butadiene is more preferred.

Units originating from the above conjugated diene compounds, such as units originating from butadiene, become ethylene units or butylene units when subjected to hydrogenation. For example, when a styrene-butadiene-styrene block copolymer (SBS) is hydrogenated, it becomes a styrene-ethylene/butylene-styrene block copolymer (SEBS).

As mentioned above, it is preferable for the aromatic vinyl elastomer used as component (III) to be one that has been hydrogenated, i.e., a hydrogenated aromatic vinyl elastomer. The hydrogenated aromatic vinyl elastomer is preferably an elastomer obtained by hydrogenating a polymer made up of polymer blocks composed primarily of an aromatic vinyl compound and a random copolymer block composed of an aromatic vinyl compound and a conjugated diene compound, and more preferably an elastomer obtained by hydrogenating a polymer made up of polymer blocks composed primarily of styrene and a random copolymer block composed of styrene and butadiene. An elastomer obtained by hydrogenating a polymer having polymer blocks composed primarily of styrene and a random copolymer block composed of styrene and butadiene, particularly a polymer having at each of two ends a polymer block composed primarily of styrene (in particular, one having at each of the two ends a polymer block consisting entirely of styrene) and having in between a random copolymer block, is especially preferred. It is thought that a lower hardness and a lower resilience are both achieved by using a copolymer having this structure. In addition, the rate of solidification after molding is rapid, and so the degree of tack is low. Also, the compatibility with the polyurethanes that together serve as the chief ingredient is excellent, enabling decreases in the physical properties owing to such blending to be held to a minimum.

Illustrative examples of the hydrogenated aromatic vinyl elastomer include styrene-ethylene/butylene-styrene block copolymers (SEBS), styrene-isobutylene-styrene block copolymers (SIBS), styrene-isoprene-styrene block copolymers (SIS), styrene-isobutylene block copolymers (SIB), styrene-ethylene/propylene-styrene block copolymers (SEPS), styrene-ethylene/ethylene/propylene-styrene block copolymers (SEEPS), styrene-butadiene/butylene-styrene block copolymers (SBBS) and styrene-ethylene-propylene block copolymers (SEP).

In the aromatic vinyl elastomer, the proportion of the copolymer accounted for by units originating from the aromatic vinyl compound (i.e., the aromatic vinyl compound content, preferably the styrene content) is preferably at least 30 wt %, more preferably at least 40 wt %, even more preferably at least 50 wt %, and most preferably at least 60 wt %. By thus setting the aromatic vinyl compound content, preferably the styrene content, to a high level, the compatibility with the thermoplastic polyurethanes serving as components (I) and (II) is good and, moreover, a worsening of the desired hardness and moldability can be prevented. The content of units from the above aromatic vinyl compound (preferably the styrene content) can be determined by calculation from H¹-NMR measurements.

In the aromatic vinyl elastomer, the glass transition temperature (Tg), as indicated by the tan δ peak temperature obtained by dynamic viscoelasticity measurement with a dynamic mechanical analyzer (DMA), is preferably from −20 to 50° C., more preferably at least 0° C., and even more preferably at least 5° C. The thinking here is that, by having the tan δ peak temperature be close to the temperature at which the golf ball is generally used, the rebound resilience of the overall resin composition is kept low in the temperature region at which the golf ball is generally used, enabling the desired effects of the invention to be increased.

A commercial product may be used as the aromatic vinyl elastomer serving as component (III). Examples of such commercial products include those available under the trademarks S.O.E., TUFTEC and TUFPREN from Asahi Kasei Corporation, and those available under the trade name DICSTYRENE from DIC Corporation.

Component (III) has a rebound resilience, as measured according to JIS-K 6255, which is preferably 40% or less, more preferably 30/o or less, and even more preferably 25% or less. By thus keeping the rebound resilience very low, a small amount of addition will not have an adverse effect on the golf ball properties, enabling a decrease in the ball initial velocity on approach shots to be achieved. To minimize the decrease in rebound and the reduction in distance on shots with a driver, it is preferable for this rebound resilience to have a lower limit of at least 20%.

It is preferable for the content of component (III) to be 50 parts by weight or less per 100 parts by weight of components (I) and (II) combined. The lower limit in this content is preferably at least 0.1 part by weight, more preferably at least 0.2 part by weight, and even more preferably at least 0.5 part by weight. When the content of component (III) is too high, the scuff resistance and moldability may worsen. On the other hand, when the content of component (III) is too low, the low hardness as a cover resin material and the desired rebound resilience may not be obtained, and the ball initial velocity lowering effect on approach shots may diminish.

In addition to the resin components described above, other resin materials may be included in the resin composition containing components (I) to (III). The purposes for doing so are, for example, to further improve the flowability of the golf ball resin composition and to increase such ball properties as the rebound and the scuff resistance.

Specific examples of other resin materials that may be used include polyester elastomers, polyamide elastomers, ionomer resins, ethylene-ethylene/butylene-ethylene block copolymers and modified forms thereof, polyacetals, polyethylenes, nylon resins, methacrylic resins, polyvinyl chlorides, polycarbonates, polyphenylene ethers, polyarylates, polysulfones, polyethersulfones, polyetherimides and polyamideimides. These may be used singly or two or more may be used together.

In addition, an active isocyanate compound may be included in the above resin composition. This active isocyanate compound reacts with the polyurethanes serving as the base resin, enabling the scuff resistance of the overall resin composition to be further increased. Moreover, the isocyanate has a plasticizing effect which increases the flowability of the resin composition, enabling the moldability to be improved.

Any isocyanate compound employed in conventional polyurethanes may be used without particular limitation as the above isocyanate compound. For example, aromatic isocyanate compounds that may be used include 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate. Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by the dimerization of isocyanate.

The amount of the above isocyanate compounds included per 100 parts by weight of the thermoplastic polyurethane resins serving as the base resin is preferably at least 0.1 part by weight, and more preferably at least 0.5 part by weight. The upper limit is preferably not more than 30 parts by weight, and more preferably not more than 20 parts by weight. When too little is included, a sufficient crosslinking reaction may not be obtained and an increase in the properties may not be observable. On the other hand, when too much is included, discoloration over time due to heat and ultraviolet light may increase, or problems such as a loss of thermoplasticity or a decline in resilience may arise.

In addition, optional additives may be suitably included in the above resin composition according to the intended use thereof. For example, when the golf ball resin composition is to be used as a cover material, various additives, such as inorganic fillers, organic staple fibers, reinforcing agents, crosslinking agents, pigments, dispersants, antioxidants, ultraviolet absorbers and light stabilizers, may be added to the ingredients described above. When such additives are included, the amount thereof per 100 parts by weight of the base resin is preferably at least 0.1 part by weight, and more preferably at least 0.5 part by weight, but preferably not more than 10 parts by weight, and more preferably not more than 4 parts by weight.

When the rebound resilience of the resin composition is too high, it has a distance-increasing effect on shots with a driver, but the ball initial velocity on approach shots is likewise high, making the ball difficult to control. For this reason, it is preferable for the rebound resilience, as measured in accordance with JIS-K 6255, to be 65% or less. To minimize decreases in the rebound and the distance of the ball on shots with a driver, it is preferable for this rebound resilience to be at least 30%.

The resin composition has a material hardness on the Shore D hardness scale which, in terms of the spin properties and scuff resistance of the golf ball, is preferably 55 or less, more preferably 50 or less, even more preferably 48 or less, and most preferably 45 or less. From the standpoint of moldability, the Shore D hardness is preferably at least 20, and more preferably at least 30.

The above resin composition may be prepared by mixing together the ingredients using any of various types of mixers, such as a kneading-type single-screw or twin-screw extruder, a Banbury mixer, a kneader or a Labo Plastomill. Alternatively, the ingredients may be mixed together by dry blending when the resin composition is to be injection-molded. In addition, when an active isocyanate compound is used, it may be incorporated at the time of resin mixture using various types of mixers, or a resin masterbatch already containing the active isocyanate compound and other ingredients may be separately prepared and the various components mixed together by dry blending when the resin composition is to be injection-molded.

The method of molding a cover layer from the above resin composition may involve, for example, feeding the resin composition into an injection molding machine and molding the cover layer by injecting the molten resin composition over a core. In this case, the molding temperature differs according to the types of thermoplastic polyurethane resins (I) and (II) serving as the chief ingredients, but is typically in the range of 150 to 270° C.

In the golf ball of this invention, letting HMb (N/mm²) be the Martens hardness of the cover layer formed of the resin composition containing components (I) to (III) and ηItb (%) be the elastic work recovery of the cover layer, it is critical for HMb and ηItb to satisfy formula (1) below.

2.00≤ηItb/HMb≤7.50 (1)

The lower limit of formula (1) is at least 2.00, preferably at least 2.50, and more preferably at least 2.70. The upper limit is not more than 7.50, preferably not more than 6.50, and more preferably not more than 6.30. When the formula (1) value is too large, the mold releasability during molding worsens or the rebound increases; when this value is too small, the scuff resistance worsens.

The Martens hardness HMb of the cover layer formed of the resin composition containing components (I) to (III) has a lower limit of preferably at least 8.00 N/mm², and more preferably at least 9.00 N/mm². The upper limit is preferably not more than 28.00 N/mm², and more preferably not more than 23.00 N/mm².

The elastic work recovery ηItb of the cover layer has a lower limit of preferably at least 50%, and more preferably at least 55%. The upper limit is preferably not more than 85%, and more preferably not more than 80%.

Letting HMa (N/mm²) be the Martens hardness of the thermoplastic polyurethane resin material composed of above components (I) and (II), from the standpoint of improving the controllability on approach shots while maintaining a good scuff resistance and moldability, it is preferable for HMa and HMb to satisfy formula (2) below.

1.005≤HMa/HMb≤1.450 (2)

The formula (2) value has a lower limit that is preferably at least 1.005, more preferably at least 1.007, and even more preferably at least 1.009. The upper limit is preferably not more than 1.450, more preferably not more than 1.400, and even more preferably not more than 1.350. At a formula (2) value that is too large, the scuff resistance and moldability may worsen. On the other hand, at a formula (2) value that is too small, the controllability on approach shots may worsen.

The Martens hardness HMa has a lower limit of preferably at least 10.00 N/mm², and more preferably at least 11.00 N/mm². The upper limit is preferably not more than 30.00 N/mm², and more preferably not more than 25.00 N/mm².

The Martens hardnesses HMa and HMb can be measured with a nanohardness tester based on ISO 14577: 2002 (“Metallic materials—Instrumented indentation test for hardness and materials parameters”). This is a physical value determined by pressing an indenter into the object being measured while applying a load to the indenter, and is calculated as (indentation force [N])/(surface area of region to which pressure is applied [mm²]). Measurement of the Martens hardness may be carried out using, for example, the nanohardness tester available from Fischer Instruments under the product name Fischerscope HM2000. This instrument can, for example, measure the hardness of the cover while continuously increasing the load in a stepwise manner. The nanohardness test conditions may be set to room temperature, 10 seconds, and an applied load of 50 mN.

When measuring the surface of the cover, in cases where a coat or the like has been formed on the cover surface, specifying the surface hardness is difficult. Also, deep positions from the cover surface toward the center of the ball are affected by the hardness of the adjacent layer. In light of such considerations, the Martens hardness inherent to the cover can be stably obtained at a position approximately 0.3 mm from the cover surface toward the center of the ball. It is thus desirable to measure the Martens hardness at this position.

At elastic work recoveries ηIta and ηItb in the above ranges, the cover formed at the golf ball surface has a high self-repairing/recovering ability while maintaining a fixed hardness and elasticity, and is able to contribute to the excellent durability and scuff resistance of the ball. Moreover, even when the Martens hardness is low, in cases where the elastic work recoveries are too low, the ball has a good spin performance on approach shots but a poor scuff resistance. The method of measuring the elastic work recoveries is described below.

The above elastic work recoveries serve as parameters of the nanoindentation method for evaluating the physical properties of the cover, this being a nanohardness test method that controls the indentation load on a micro-newton (μN) order and tracks the indenter depth during indentation to a nanometer (nm) precision. In prior methods, only the size of the deformation (plastic deformation) mark corresponding to the maximum load could be measured. However, in the nanoindentation method, the relationship between the indentation load and the indentation depth can be obtained by continuous automated measurement. Hence, unlike in the past, there are no individual differences between observers when visually measuring a deformation mark under an optical microscope, and so it is thought that the physical properties of the cover can be reliably measured to a high precision. Given that the golf ball cover is strongly affected by the impact of drivers and other types of clubs and has a not inconsiderable influence on various golf ball properties, measuring the cover by the nanohardness test method and carrying out such measurement to a higher precision than in the past is a very effective method of evaluation.

The above resin composition preferably has a melt viscosity at 200° C. and a shear rate of 243 sec⁻¹ of from 0.2×10⁴ to 2.5×10⁴ dPa·s. A melt viscosity in this range confers the resin composition with a suitable fluidity and with a suitable ability to solidify after molding, making it possible to suppress a decline in moldability (productivity). This melt viscosity, when measured at 200° C. with a capillary rheometer in accordance with ISO 11443: 1995, indicates the melt viscosity at a shear velocity of 243 sec⁻¹.

The cover has a thickness of preferably at least 0.4 mm, more preferably at least 0.5 mm, and even more preferably at least 0.6 mm. The upper limit is preferably not more than 3.0 mm, and more preferably not more than 2.0 mm.

One or more intermediate layer may be interposed between the above core and the above cover. In this case, it is preferable to employ any of various types of thermoplastic resins used in golf ball cover materials, especially an ionomer resin, as the intermediate layer material. A commercial product may be used as the ionomer resin.

In the golf ball of the invention, for reasons having to do with the aerodynamic performance, numerous dimples are provided on the surface of the outermost layer. The number of dimples formed on the surface of the outermost layer is not particularly limited. However, to enhance the aerodynamic performance and increase the distance traveled by the ball, this number is preferably at least 250, more preferably at least 270, even more preferably at least 290, and most preferably at least 300. The upper limit is preferably not more than 400, more preferably not more than 380, and even more preferably not more than 360.

In this invention, a coating layer is formed on the cover surface. A two-part curable urethane coating may be suitably used as the coating that forms this coating layer. Specifically, in this case, the two-part curable urethane coating is one that includes a base resin composed primarily of a polyol resin and a curing agent composed primarily of a polyisocyanate.

A known method may be used without particular limitation as the method for applying this coating onto the cover surface and forming a coating layer. Use can be made of a desired method such as air gun painting or electrostatic painting.

The thickness of the coating layer, although not particularly limited, is typically from 8 to 22 μm, and preferably from 10 to 20 μm.

The golf ball of the invention can be made to conform to the Rules of Golf for play. The inventive ball may be formed to a diameter which is such that the ball does not pass through a ring having an inner diameter of 42.672 mm and is not more than 42.80 mm, and to a weight which is preferably between 45.0 and 45.93 g.

### EXAMPLES

The following Examples and Comparative Examples are provided to illustrate the invention, and are not intended to limit the scope thereof. The results shown below for Examples 3 to 5 and 8 to 10 and for Comparative Examples 1 to 3, 5 and 8 are actual measurements. The results shown for the other Examples, namely Examples 1, 2, 6, 7 and 11 to 15 and Comparative Examples 4, 6 and 7, are predicted values inferred from Examples 3 to 5 and 8 to 10 and Comparative Examples 1 to 3, 5 and 8 under the conditions indicated below.

### Examples 1 to 15. Comparative Examples 1 to 8

A core-forming rubber composition formulated as shown in Table 1 and common to all of the Examples is prepared and then molded and vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of pentachlorothiophenol | 0.3 |
| Zinc stearate | 1.0 |

Details on the above core material are given below.
Cis-1,4-Polybutadiene: Available under the trade name “BR 01” from JSR Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

Next, an intermediate layer-forming resin material common to all of the Examples is formulated. This intermediate layer resin material is a blend of 50 parts by weight of a sodium-neutralized ethylene-unsaturated carboxylic acid copolymer having an acid content of 18 wt % and 50 parts by weight of a zinc-neutralized ethylene-unsaturated carboxylic acid copolymer having an acid content of 15 wt % (for a combined amount of 100 parts by weight). This resin material is injection molded over a core having a diameter of 38.6 mm, thereby producing an intermediate layer-encased sphere having an intermediate layer with a thickness of 1.25 mm.

Next, the cover materials shown in Tables 2 and 3 below are injection-molded over the intermediate layer-encased spheres in the amounts indicated in these tables, thereby producing 42.7 mm diameter three-piece golf balls having a cover layer (outermost layer) with a thickness of 0.8 mm. Although not shown in the diagram, dimples common to all of the Working Examples and Comparative Examples are formed on the surface of the cover.

### Preparation of Cover (Outermost Laver)-Forming Resin Composition

The ingredients are mixed in the amounts shown in Tables 2 and 3 by dry blending, and the resulting resin compositions are injection-molded at a molding temperature of between 210° C. and 250° C. The numbers in the tables indicate the parts by weight.

Details on the ingredients included in the compositions in Tables 2 and 3 are given below.
TPU 1: An ether-type thermoplastic polyurethane available from DIC Covestro Polymer, Ltd. under the trade name “Pandex” (polyol component: PTMG having a number-average molecular weight of 2,000; Shore D hardness, 43)
TPU 2: An ether-type thermoplastic polyurethane available from DIC Covestro Polymer, Ltd. under the trade name “Pandex” (polyol component: PTMG having a number-average molecular weight of 1,000; Shore D hardness, 43)
TPU 3: An ether-type thermoplastic polyurethane available from DIC Covestro Polymer, Ltd. under the trade name “Pandex” (polyol component: PTMG having a number-average molecular weight of 2,000; Shore D hardness, 47)
TPU 4: An ether-type thermoplastic polyurethane available from DIC Covestro Polymer, Ltd. under the trade name “Pandex” (polyol component: PTMG having a number-average molecular weight of 1,000; Shore D hardness, 47)
S.O.E. S1611:
   A hydrogenated aromatic vinyl elastomer available from Asahi Kasei Corporation (styrene content, 60 wt %; Shore D hardness, 23; rebound resilience, 20%)

The Martens hardnesses (HMa) and elastic work recoveries (Alta) of the polyurethane resins (TPU1 to TPU4) used in the Working Examples and the Comparative Examples are respectively measured by the methods described below. In addition, the Martens hardnesses (HMb) and elastic work recoveries (gltb) of the cover layer (outermost layer) resin compositions used in the Working Examples and Comparative Examples are each measured. Next, the two following relationships among these parameters are calculated:

ηItb/HMb, and Formula (1):

HMa/HMb. Formula (2):

The calculated values are shown in Tables 2 and 3.

### Martens Hardness (HMb) of Outermost Layer (Cover Layer)

The golf ball in each Example is cut in half and, specifying a position on the ball cross-section that is located 0.3 mm from the surface of the cover toward the ball center, the Martens hardness HMb (N/mm²) at this place is measured using the nanohardness tester available from Fischer Instruments under the product name Fischerscope HM2000. The nanohardness measurement conditions are room temperature and an applied load of 50 mN/10 s.

### Martens Hardness (HMa) of Thermoplastic Polyurethane Resin Material

The Martens hardnesses (HMa) of the thermoplastic polyurethane resin materials are measured in the same way as above.

The Martens hardnesses (HMa) obtained for the respective thermoplastic polyurethane resins (TPU1 to TPU4) are shown below. The apparatus and conditions used for measuring the Martens hardnesses of these resins are the same as those mentioned above.
Martens hardness (HMa) of TPU1: 14.3 N/mm²
Martens hardness (HMa) of TPU2: 13.8 N/mm²
Martens hardness (HMa) of TPU3: 22.1 N/mm²
Martens hardness (HMa) of TPU4: 20.0 N/mm²

### Elastic Work Recovery of Cover Layer (Outermost Layer)

The elastic work recovery of the cover layer is measured using the nanohardness tester available from Fischer Instruments under the product name Fischerscope HM2000. The measurement conditions are room temperature and an applied load of 50 mN/10 s. The elastic work recovery is calculated as follows, based on the indentation work Wₑₗₐₛₜ (Nm) due to spring-back deformation of the cover and on the mechanical indentation work Wₜₒₜₐₗ (Nm).

Elastic work recovery=Wₑₗₐₛₜ/Wₜₒₜₐₗ×100(%)

### Elastic Work Recovery of Resin Material

The elastic work recoveries (%) of the respective polyurethane resins (TPU1 to TPU4) are shown below. The apparatus and conditions used for measuring the elastic work recoveries of these resins are the same as those mentioned above.
Elastic work recovery of TPU1: 72%
Elastic work recovery of TPU2: 71%
Elastic work recovery of TPU3: 57%
Elastic work recovery of TPU4: 56%

### Melt Viscosity

The melt viscosities of the resin compositions in the respective Examples at a shear rate of 243 sec⁻¹ when measured with a capillary rheometer at 200° C. in accordance with TSO 11443: 1995 are shown in Tables 2 and 3.

### Ball Properties on Approach Shots

For the golf balls obtained in the respective Working Examples and Comparative Examples, a sand wedge (SW) is mounted on a golf swing robot and the initial velocity and backspin rate of the ball immediately after being struck at a head speed (HS) of 20 m/s are measured with a launch monitor. These measured values are shown in Tables 2 and 3.

Sensory evaluations of the club maneuverability on approach shots are carried out based on the following criteria. The results are shown in Tables 2 and 3.

Good: Superior maneuverability

Fair: Good maneuverability

NG: Inferior maneuverability

### Evaluation of Scuff Resistance

The golf balls are held isothermally at 23° C. and five balls of each type are hit at a head speed of 33 m/s using as the club a pitching wedge mounted on a swing robot machine. The damage to the ball from the impact is visually rated according to the following criteria. The results are shown in Tables 2 and 3.

Good: Slight scuffing or substantially no apparent scuffing.

Fair: Slight fraying of surface or slight dimple damage.

NG: Dimples completely obliterated in places.

### Evaluation of Moldability (Mold Releasability)

Releasability of the ball from the mold following injection molding of the cover is rated according to the following criteria for the balls in each Example. The results are shown in Tables 2 and 3.
Good: External defects such as runner stubs and ejector pin marks do not arise during demolding.
NG: External defects such as runner stubs and ejector pin marks arise during demolding, making molding impossible.

TABLE 2

| | | | Example | | | | | | | |
|---|---|---|---|---|---|---|---|---|---|---|
| | | | 1 | 2 | 3 | 4 | 5 | 6 | 7 | 8 |
| Outermost | Component (I) | TPU 1 | 99 | 95 | 90 | 75 | 50 | 99 | 95 | 90 |
| Layer | Component (II) | TPU 2 | 1 | 5 | 10 | 25 | 50 | 1 | 5 | 10 |
| | Component (III) | S.O.E. S1611 | 3 | 3 | 3 | 3 | 3 | 50 | 50 | 50 |
| | Formula (1) | ηItb/HMb | 5.11 | 5.10 | 5.09 | 5.06 | 5.02 | 6.38 | 6.32 | 6.25 |
| | — | Component (II)/ | 0.01 | 0.05 | 0.11 | 0.33 | 1.00 | 0.01 | 0.05 | 0.11 |
| | | Component (I) | | | | | | | | |
| | Formula (2) | HMa/HMb | 1.02 | 1.02 | 1.02 | 1.02 | 1.02 | 1.35 | 1.35 | 1.35 |

| | Melt viscosity (dPa · s) | 1.05 | 1.05 | 1.06 | 1.08 | 1.12 | 1.00 | 1.01 | 1.01 |
|---|---|---|---|---|---|---|---|---|---|
| Evaluation | Spin rate | 6,383 | 6,363 | 6,338 | 6,265 | 6,142 | 5,993 | 5,973 | 5,948 |
| | on approach shots (rpm) | | | | | | | | |
| | Initial velocity | 19.11 | 19.10 | 19.09 | 19.06 | 19.01 | 18.61 | 18.60 | 18.59 |
| | on approach shots (m/s) | | | | | | | | |
| | Scuff resistance | good | good | good | good | good | good | good | good |
| | Controllability | good | good | good | good | good | good | good | good |
| | on approach shots | | | | | | | | |
| | Moldability | good | good | good | good | good | good | good | good |
| | | | Example | | Comparative Example | | | | |
| | | | 9 | 10 | 1 | 2 | 3 | 4 | 5 |
| Outermost | Component (I) | TPU 1 | 75 | 50 | 100 | — | 100 | 100 | 25 |
| Layer | Component (II) | TPU 2 | 25 | 50 | — | 100 | — | — | 75 |
| | Component (III) | S.O.E. S1611 | 50 | 50 | 3 | 0 | 0 | 100 | 3 |
| | Formula (1) | ηItb/HMb | 6.03 | 5.66 | 5.11 | 4.93 | 5.02 | 7.53 | 5.04 |
| | — | Component (II)/ | 0.33 | 1.00 | 0.00 | — | 0.00 | 0.00 | 3.00 |
| | | Component (I) | | | | | | | |
| | Formula (2) | HMa/HMb | 1.35 | 1.35 | 1.02 | 1.00 | 1.00 | 1.64 | 1.02 |

| | | | | | | | | |
|---|---|---|---|---|---|---|---|---|
| | Melt viscosity (dPa · s) | 1.03 | 1.05 | 1.05 | 1.20 | 1.05 | 0.98 | 1.16 |
| Evaluation | Spin rate | 5,875 | 5,752 | 6,404 | 6,058 | 6,447 | 5,690 | 6,042 |
| | on approach shots (rpm) | | | | | | | |
| | Initial velocity | 18.56 | 18.51 | 19.21 | 18.89 | 19.24 | 18.40 | 18.61 |
| | on approach shots (m/s) | | | | | | | |
| | Scuff resistance | good | good | good | good | good | NG | good |
| | Controllability | good | good | fair | good | fair | good | good |
| | on approach shots | | | | | | | |
| | Moldability | good | good | good | NG | good | good | NG |

The following is apparent from the results in Table 2.

In Examples 1 to 5 according to the invention, the amount of component (III) is set to 3 parts by weight and the ratio (II)/(I) is gradually increased, whereupon the initial velocity on approach shots decreases and the controllability rises. At the same time, the ball retains a good moldability and scuff resistance.

In Examples 6 to 10 according to the invention, unlike in Examples 1 to 5, the amount of component (III) is increased from 3 parts by weight to 50 parts by weight, whereupon the controllability rises.

Comparative Example 1 includes 3 parts by weight of component (III) but, unlike in Example 1, does not include the PTMG having a molecular weight of 1,000 of component (II) and so has a poor controllability on approach shots.

Comparative Example 2 is an example in which only component (II) is included; components (I) and (III) are not included. The controllability on approach shots is good, but the moldability is poor and production defects arise.

Comparative Example 3 is an example in which only component (I) is included; components (II) and (III) are not included. The moldability and scuff resistance are good, but the controllability on approach shots is poor.

Comparative Example 4 is an example which includes only component (I) as the thermoplastic polyurethane resin and which includes excess component (III). The controllability on approach shots is good, but the scuff resistance is exceedingly poor.

In Comparative Example 5, the ratio (II)/(I) is larger than 3.00, and so the controllability on approach shots is good. However, the moldability is poor and production defects arise.

TABLE 3

| | | | Example | | | | | Comparative Example | | |
|---|---|---|---|---|---|---|---|---|---|---|
| | | | 11 | 12 | 13 | 14 | 15 | 6 | 7 | 8 |
| Outermost | Component (I) | TPU 3 | 99 | 95 | 90 | 75 | 50 | 100 | — | 100 |
| Layer | Component (II) | TPU 4 | 1 | 5 | 10 | 25 | 50 | — | 100 | — |
| | Component (III) | S.O.E. S1611 | 3 | 3 | 3 | 3 | 3 | 3 | 0 | 0 |
| | Formula (1) | ηItb/HMb | 2.65 | 2.66 | 2.66 | 2.67 | 2.68 | 2.65 | 2.71 | 2.75 |
| | — | Component (II)/ | 0.01 | 0.05 | 0.11 | 0.33 | 1.00 | — | — | 0.00 |
| | | Component (I) | | | | | | | | |
| | Formula (2) | HMa/HMb | 1.03 | 1.03 | 1.03 | 1.03 | 1.03 | 1.03 | 1.00 | 1.00 |

| | | | | | | | | | |
|---|---|---|---|---|---|---|---|---|---|
| | Melt viscosity (dPa · s) | 1.39 | 1.40 | 1.41 | 1.43 | 1.48 | 1.39 | 1.60 | 1.40 |
| Evaluation | Spin rate on approach shots (rpm) | 6,453 | 6,133 | 6,108 | 6,035 | 5,912 | 5,666 | 5,666 | 6,158 |
| | Initial velocity on approach shots (m/s) | 19.01 | 19.00 | 18.99 | 18.96 | 18.91 | 18.81 | 18.81 | 19.11 |
| | Scuff resistance | good | good | good | good | good | good | good | good |
| | Controllability on approach shots | good | good | good | good | good | fair | good | fair |
| | Moldability | good | good | good | good | good | good | NG | good |

The following is apparent from the results in Table 3.

Examples 11 to 15 are examples in which the thermoplastic polyurethane resins used have a Shore D hardness of 47, and so are harder than the thermoplastic polyurethane resins in Examples 1 to 10 in Table 2. In these Examples, as in Examples 1 to 5, upon setting the amount of component (III) to 3 parts by weight and gradually increasing the ratio (II)/(I), the initial velocity on approach shots decreases and the controllability rises. At the same time, the ball retains a good moldability and Scuff resistance.

Comparative Example 6 includes 3 parts by weight of component (III) but, unlike in Example 11, does not include the PTMG having a molecular weight of 1,000 of component (II) and so has a poor controllability on approach shots.

Comparative Example 7 is an example in which only component (II) is included; components (I) and (III) are not included. The controllability on approach shots is good, but the moldability is poor and production defects arise.

Comparative Example 8 is an example in which only component (I) is included; components (II) and (III) are not included. The moldability and scuff resistance are good, but the controllability on approach shots is poor.

Japanese Patent Application No. 2020-192333 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core of at least one layer and a cover of one or more layer encasing the core, wherein at least one layer of the cover is formed of a resin composition which comprises:
(I) a thermoplastic polyurethane resin that uses, as a polyol component, polytetramethylene glycol having a number-average molecular weight of from 1,900 to 2,100,
(II) a thermoplastic polyurethane resin that uses, as a polyol component, polytetramethylene glycol having a number-average molecular weight of from 900 to 1,100, and
(III) an aromatic vinyl elastomer,
and in which components (I) and (II) are compounded in a weight ratio (II)/(I) of from 0.01 to 1.10; and, letting HMb (N/mm²) be the Martens hardness of the cover layer formed of the resin composition containing components (I) to (III) and ηItb (%) be the elastic work recovery of the cover layer, HMb and ηItb satisfy formula (1) below
2.00≤ηItb/HMb≤7.50 (1).

2. The golf ball of claim 1, wherein ηItb/HMb in formula (1) has a lower limit value of 2.50 and an upper limit value of 6.50.

3. The golf ball of claim 1, wherein the weight ratio (II)/(I) in which components (I) and (II) are compounded is from 0.05 to 0.8.

4. The golf ball of claim 1 wherein, letting HMa (N/mm²) be the Martens hardness of the thermoplastic polyurethane resin material composed of components (I) and (II), the golf ball satisfies formula (2) below
1.005≤HMa/HMb≤1.450 (2).

5. The golf ball of claim 1, wherein the content of component (III) is 50 parts by weight or less per 100 parts by weight of components (I) and (II) combined.

6. The golf ball of claim 1, wherein component (III) is a hydrogenated aromatic vinyl elastomer.

7. The golf ball of claim 1, wherein component (III) is an elastomer obtained by hydrogenating a polymer comprising polymer blocks composed primarily of an aromatic vinyl compound and a random copolymer block of an aromatic vinyl compound and a conjugated diene compound.

8. The golf ball of claim 1, wherein component (III) is a hydrogenated aromatic vinyl elastomer obtained by hydrogenating a polymer comprising, at each of two ends thereof, a polymer block composed of styrene and, in between, a random copolymer block composed of styrene and butadiene.

9. The golf ball of claim 1, wherein the resin composition has a melt viscosity at 200° C. and a shear rate of 243 sec⁻¹ that is from 0.2×10⁴ to 2.5×10⁴ dPa·s.
